(19) United States
(12) Patent Application Publication
(10) Pub. No.: US 2007/0099806 A1
(43) Pub. Date: May 3, 2007

(54) Composition and method for selectively removing native oxide from silicon-containing surfaces

(76) Inventors: Michael P. Stewart, Mountain View, CA (US); Timothy W. Weidman, Sunnyvale, CA (US)

Correspondence Address: PATTERSON & SHERIDAN, LLP, 3040 POST OAK BOULEVARD, SUITE 1500, HOUSTON, TX, 77056, US

(21) Appl. No.: 11/385,041

(22) Filed: Mar. 20, 2006

Related U.S. Application Data
(60) Provisional application No. 60/731,624, filed on Oct. 28, 2005.

(51) Int. Cl. C11D 7/32

(52) U.S. Cl. 510/175

(57) ABSTRACT

Embodiments of the invention are provided which include compositions of buffered oxide etch (BOE) solutions and methods that use the BOE solutions during a process to selectively remove a native oxide layer from a substrate surface containing thermal oxide layers. The BOE solutions generally contain HF and alkanolamine compounds. The viscosity of the BOE solution may be adjusted by varying a concentration ratio of at least two alkanolamine compounds. In one example, a BOE solution is provided which includes, by weight, a first alkanolamine concentration within a range from about 0.5% to about 10%, a second alkanolamine concentration within a range from about 0.5% to about 10%, a HF concentration within a range from about 0.5% to about 10%, a water concentration within a range from about 80% to about 98%, a pH value within a range from about 3.5 to about 5, and a viscosity within a range from about 10 cP to about 30 cP.

### CROSS-REFERENCE TO RELATED APPLICATIONS

This application claims benefit of U.S. Ser. No. 60/731,624, filed Oct. 28, 2005 (01 0659L), which is herein incorporated by reference in its entirety.

### BACKGROUND OF THE INVENTION

1. Field of the Invention

Embodiments of the invention generally relate to compositions and methods for etching, and more particular to compositions of etching solutions and methods that maybe used to selectively etching native oxides.

2. Description of the Related Art

Different types of cleaning and etching compositions and processes have been used during the fabrication of microelectronic components. Etching processes for removing material, sometimes in selective areas, have been developed and are utilized to varying degrees. Moreover, the steps of etching different layers which constitute, for instance, the finished integrated circuit chip are among the most critical and crucial steps. Often, an oxide-free silicon surface of a substrate is essential prior to performing a subsequent process. In many processes, the silicon substrate is processed to form contacts, vias and other apertures, as well as other fabricated features. Subsequently, the substrate surface contains undesirable native oxides and desired thermal oxides contained within features.

Native oxide surfaces generally contain a metastable lower quality oxide (e.g. , SiOₓ, where x is usually less than 2) compared to the much more stable oxide materials that are typically used to form features (e.g. , SiO₂), such as thermal oxides. The lower-density native oxide, having a larger concentration of defects, is much easier to remove from a substrate surface than most thermally deposited oxides. However, many etch solutions that are effective at removing native oxides also remove or damage desirable thermal oxides. Buffered oxide etch (BOE) solutions have been used to remove native oxides, but suffers from a lack of selectivity and also etches thermal oxides. BOE solutions are often highly acidic aqueous solution (e.g. , pH <3.5) containing complexes of hydrofluoric acid and a conjugate such as ammonia (NH₃) or tetramethylammonium hydroxide ((CH₃)₃N(OH)).

Alternatively, plasma-assisted cleaning processes have been used to remove native oxide layers from substrate surfaces. Usually, a plasma-assisted cleaning process removes oxygen atoms from the substrate surface by chemically reducing the oxide with atomic-hydrogen. A plasma-assisted cleaning process is usually faster than other cleaning processes, such as a BOE process. However, plasma-assisted cleaning processes suffer many shortcomings that include providing little or no oxide selectivity (i.e. , native oxide over thermal oxide), over etching, and plasma damage to various regions on the substrate surface.

Therefore, there is a need for an etching process and composition that may be used to selectively remove native oxides over thermal oxides.

### SUMMARY OF THE INVENTION

Embodiments of the invention are provided which include compositions of buffered oxide etch (BOE) solutions and methods that use the BOE solutions during a process to selectively remove a native oxide layer from a substrate surface. The BOE solutions generally contain alkanolamine compounds and an etchant, such as hydrogen fluoride. In one embodiment, the viscosity of the BOE solution may be adjusted by varying a concentration ratio of at least two alkanolamine compounds. A BOE solution having a viscosity within a range from about 10 cP to about 30 cP has superior wetting properties on a substrate surface during a process to selectively remove native oxide layers therefrom.

In one embodiment, a composition of a BOE solution is provided which includes, by weight, a first alkanolamine compound at a concentration within a range from about 0.5% to about 10%, a second alkanolamine compound at a concentration within a range from about 0.5% to about 10%, hydrogen fluoride at a concentration within a range from about 0.5% to about 10%, water at a concentration within a range from about 80% to about 98%, a pH value within a range from about 3.5 to about 5, and a viscosity within a range from about 10 cP to about 30 cP. In one example, the first alkanolamine compound is at a concentration within a range from about 1% to about 5%, the second alkanolamine compound is at a concentration within a range from about 1% to about 5%, the hydrogen fluoride is at a concentration within a range from about 1% to about 5%, the water is at a concentration within a range from about 85% to about 95%, the pH value is within a range from about 3.8 to about 4.8, and the viscosity is within a range from about 12 cP to about 28 cP. In another example, the first alkanolamine compound is at a concentration within a range from about 2% to about 3%, the second alkanolamine compound is at a concentration within a range from about 2% to about 3%, the hydrogen fluoride is at a concentration within a range from about 1% to about 3%, the water is at a concentration within a range from about 88% to about 94%, the pH value is within a range from about 3.5 to about 5, preferably, from about 4 to about 4.5, and the viscosity is less than about 50 cP, such as within a range from about 15 cP to about 25 cP. In another example, the first alkanolamine compound is at a concentration of about 3%, the second alkanolamine compound is at a concentration of about 2%, the hydrogen fluoride is at a concentration of about 2%, the water is at a concentration of about 92%, the pH value is within a range from about 4 to about 4.5, and the viscosity is less than about 50 cP, such as within a range from about 15 cP to about 25 cP.

In another embodiment, a weight ratio of the first alkanolamine compound to the second alkanolamine compound is within a range from about 1 to about 5, for example, about 1.5. The first and second alkanolamine compounds may be different alkanolamine compounds selected from ethanolamine (EA), diethanolamine (DEA), triethanolamine (TEA), or derivatives thereof. For example, the first alkanolamine compound may be DEA and the second alkanolamine compound may be TEA. In another example, the first alkanolamine compound is DEA the second alkanolamine compound is EA. In another example, the first alkanolamine compound is TEA the second alkanolamine compound is EA. In other examples, the first alkanolamine compound is DEA at a concentration to have the viscosity within a range from about 15 cP to about 25 cP or at a concentration by weight within a range from about 1% to about 15%.

In another embodiment, a composition of a BOE etch solution is provided which includes a first alkanolamine and a second alkanolamine compound at a weight ratio concentration to form a viscosity within a range from about 10 cP to about 30 cP, hydrogen fluoride at a concentration by weight within a range from about 0.5% to about 10%, water at a concentration by weight within a range from about 80% to about 98%, a pH value within a range from about 3.5 to about 5, and a viscosity within a range from about 10 cP to about 30 cP. The first and second alkanolamine compounds may include EA, DEA, TEA, or other alkanolamine derivatives. In one example, the weight ratio concentration of the first alkanolamine compound to the second alkanolamine compound is within a range from about 1 to about 5, such as about 1.5 or about 1.1. In another example, the viscosity of the BOE solution is within a range from about 12 cP to about 28 cP, preferably, from about 15 cP to about 25 cP.

In another embodiment, a composition of the BOE solution is provided which further includes a pH adjusting agent, such as hydrofluoric acid, additional alkanolamine compounds, sulfuric acid, ammonium hydroxide, tetramethylammonium hydroxide, derivatives thereof, or combinations thereof. In one example, the BOE solution contains the pH adjusting agent at a concentration to have a pH value within a range from about 3.5 to about 5, preferably, from about 3.8 to about 4.8, and more preferably, from about 4 to about 4.5.

In another embodiment, a method for selectively removing an oxide layer from a substrate surface is provided which includes providing a substrate having a native oxide surface and a feature surface, exposing the substrate to a buffered oxide etch solution to remove the native oxide surface, form a native surface, and preserve the feature surface on the substrate. In one example, the buffered oxide etch solution contains a first alkanolamine compound at a concentration by weight within a range from about 0.5% to about 10%, a second alkanolamine compound at a concentration by weight within a range from about 0.5% to about 10%, hydrogen fluoride at a concentration by weight within a range from about 0.5% to about 10%, water at a concentration by weight within a range from about 80% to about 98%, a pH value within a range from about 3.5 to about 5, and a viscosity within a range from about 10 cP to about 30 cP.

In another embodiment, a composition of a BOE solution is provided which includes DEA at a concentration by weight within a range from about 0.5% to about 10%, TEA at a concentration by weight within a range from about 0.5% to about 10%, HF at a concentration by weight within a range from about 0.5% to about 10%, water at a concentration by weight within a range from about 80% to about 98%, a pH value within a range from about 3.5 to about 5 and a viscosity within a range from about 10 cP to about 30 cP.

In one example, the composition of the buffered oxide etch solution contains the DEA at a concentration within a range from about 1% to about 5%, the TEA at a concentration within a range from about 1% to about 5%, the HF at a concentration within a range from about 1% to about 5%, the water at a concentration within a range from about 85% to about 95%, the pH value within a range from about 3.8 to about 4.8, and the viscosity within a range from about 12 cP to about 28 cP. In another example, the composition of the buffered oxide etch solution contains the DEA at a concentration within a range from about 2% to about 3%, the TEA is at a concentration within a range from about 2% to about 3%, the HF is at a concentration within a range from about 1% to about 3%, the water is at a concentration within a range from about 88% to about 94%, the pH value is within a range from about 4 to about 4.5, and the viscosity is within a range from about 15 cP to about 25 cP. In another example, the composition of the buffered oxide etch solution contains the DEA is at a concentration of about 3%, the TEA is at a concentration of about 2%, the HF is at a concentration of about 2%, the water is at a concentration of about 92%, the pH value is within a range from about 4 to about 4.5, and the viscosity is within a range from about 15 cP to about 25 cP. The weight ratio of the DEA to the TEA is within a range from about 1 to about 5, preferably, the weight ratio is about 1.5 or less and the viscosity is about 23 cP.

In another embodiment, a method for selectively removing an oxide layer from a substrate surface is provided which includes providing a substrate having a native oxide surface and a feature surface and exposing the substrate to a buffered oxide etch solution to remove the native oxide surface while forming a native surface and preserving the feature surface on the substrate. The BOE solution may contain DEA at a concentration by weight within a range from about 0.5% to about 10%, TEA at a concentration by weight within a range from about 0.5% to about 10%, HF at a concentration by weight within a range from about 0.5% to about 10%, water at a concentration by weight within a range from about 80% to about 98%, a pH value within a range from about 3.5 to about 5, and a viscosity within a range from about 10 cP to about 30 cP. The pH value of the BOE solution may be adjusted to a point of zero charge of silicon, such as within a range from about 4 to about 4.5. The BOE solution may have a weight ratio of the DEA to the TEA within a range from about 1 to about 5. In one example of the BOE solution, the weight ratio is about 1.5 and the viscosity is about 23 cP.

The method further provides that the substrate is exposed to the BOE solution for a time period within a range from about 10 seconds to about 120 seconds, preferably, from about 15 seconds to about 60 seconds, for example, about 30 seconds. The substrate may be exposed to a rinse solution subsequent to the BOE solution. Thereafter, a metal-containing material, such as a barrier layer or a metal silicide layer, may be deposited or formed on the native surface.

### BRIEF DESCRIPTION OF THE DRAWINGS

So that the manner in which the above recited features of the invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a flow chart for a process described by an embodiment herein; and

FIGS. 2A-2E illustrate cross-sectional views of a substrate during different stages of fabrication processes described by embodiments herein.

### DETAILED DESCRIPTION

Embodiments of the invention are provided, which include compositions of buffered oxide etch (BOE) solutions and methods that use the BOE solutions during a process to selectively remove a native oxide layer from a substrate surface containing thermal oxides. The BOE solutions generally contain alkanolamine compounds and an etchant, such as hydrogen fluoride. In one embodiment, the viscosity and the wetting properties of the BOE solution may be adjusted by varying a concentration ratio of at least two alkanolamine compounds.

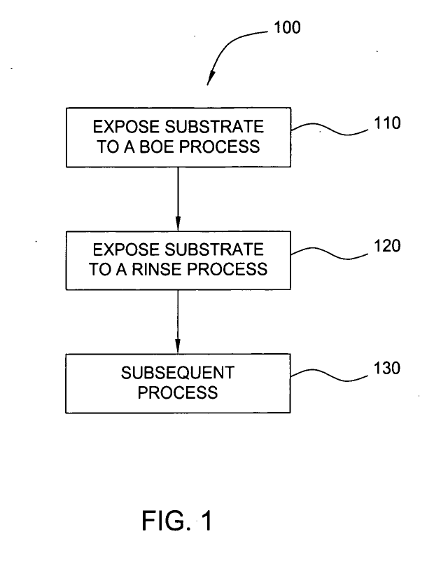

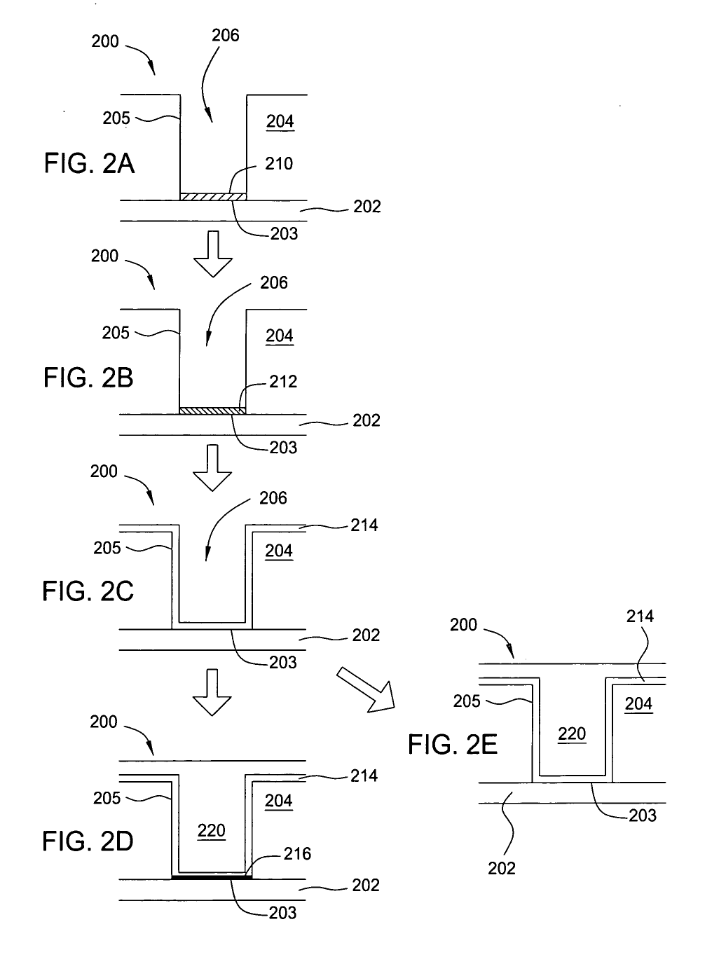

FIG. 1 illustrates a flow chart of process sequence 100 for cleaning substrates, such as during a contact cleaning application. In one embodiment, process sequence 100 corresponds to FIGS. 2A-2E which illustrate schematic cross-sectional views of an electronic device at different stages of an interconnect fabrication sequence. Process sequence 100 includes process 110 for exposing substrate 200 to a BOE solution during the contact cleaning application, process 120 for rinsing substrate 200 during a rinse application and process 130 for subsequent processes, including depositing or forming at least one material on substrate 200.

FIG. 2A illustrates a cross-sectional view of substrate 200 having contact level aperture 206 formed within dielectric layer 204. Aperture 206 contains sidewalls 205 extending from the field of substrate 200 to silicon junction 202. Dielectric layer 204 may generally contain an insulating material that includes silicon dioxide and other silicon oxides, silicon on insulator (SOI), silicon oxynitride, fluorine-doped silicate glass (FSG), or carbon-doped silicon oxides, such as SiOₓC_{y}, for example, BLACK DIAMOND® low-k dielectric, available from Applied Materials, Inc., located in Santa Clara, Calif. Contact level aperture 206 may be formed in dielectric layer 204 using conventional lithography and etching techniques to expose silicon junction 202. Alternatively, dielectric layer 204 may be deposited on silicon junction 202 forming contact level aperture 206 therein. Silicon junction 202 may be a MOS type source or a drain interface and is generally a doped (e.g. , n+ or p+) silicon region of substrate 200.

Native oxide surface 210 is typically formed on exposed surface 203 of silicon junction 202 during an exposure to air or after the etching and ashing processes used to form contact level aperture 206. Native oxide surface 210 may be a continuous layer or a discontinuous layer across exposed surface 203 and include surface terminations of oxygen, hydrogen, hydroxide, halide, metals, or combinations thereof. Native oxide surface 210 formed at silicon junction 202 is generally a metastable lower quality oxide (e.g. , SiOₓ, where x is between 0 and 2) compared to the much more stable oxide materials that are typically used to form dielectric layer 204 (e.g. , SiO₂), such as thermal oxides. The metastable lower quality oxide (e.g. , the “native oxide”) is much easier to remove from exposed surface 203 than dielectric layer 204, probably due to a lower activation energy than that of dielectric layer 204.

In one embodiment, substrate 200 may be exposed to a pretreatment process to further clean native oxide surface 210 prior to process 110. Contaminants resulting from exposure to ambient conditions may accumulate on native oxide surface 210 during or after the formation of contact level aperture 206. In one example, a contaminant is a hydrocarbon-containing or fluorocarbon-containing residue which reduces or prevents the wetting of native oxide surface 210 during subsequent processes, such as process 110. Therefore, a wet clean process may be used to remove residues and other contaminants from substrate 200, yielding native oxide surface 210 free or substantially free of contaminants. Substrate 200 may be treated by wet clean processes, such as an acidic cleaning process (e.g. , a solution containing hydrochloric acid and hydrogen peroxide held at elevated temperature, such as SC2 clean), a basic cleaning process (e.g. , a solution containing ammonium hydroxide and hydrogen peroxide held at elevated temperature, such as SC1 clean), or a series of wet cleans containing both acidic and basic cleaning processes.

Substrate 200 may be exposed to a BOE solution for removing native oxide surface 210 while forming hydride surface 212, as depicted in FIG. 2B. Hydride surface 212 is formed on exposed surface 203 of silicon junction 202 during process 110. Hydride surface 212 may contain silicon, silicon hydrides (e.g. , SiHₓ, where x=1, 2 or 3), silicon hydroxides (e.g. , Si(OH)ₓ, where x=1, 2 or 3), or combinations thereof (e.g. , SiHₓ(OH)_{y}, where x=1 or 2 and y=1 or 2). In one embodiment, the formation of hydride surface 212 may be used to facilitate a subsequent metal deposition process during process 130. In general, the formation of silicon hydrides within hydride surface 212 is preferred over silicon hydroxides, since silicon hydrides have a less chance than silicon hydroxides of incorporating oxygen into subsequently deposited/formed materials (e.g. , metal films or silicide contacts).

FIG. 2B illustrates a cross-sectional view of substrate 200 containing contact level aperture 206 after hydride surface 212 has been formed on silicon junction 202. In one embodiment, the metastable low quality oxide of native oxide surface 210 is selectively removed and hydride surface 212 is formed on exposed surface 203 by exposing substrate 200 to a BOE solution. Dielectric layer 204 may sustain little etching or no etching during the time period for removing native oxide surface 210. Generally, process 110 occurs for less than about 5 minutes, preferably, less than about 3 minutes, such as within a range from about 10 seconds to about 120 seconds, preferably, from about 15 seconds to about 60 seconds, for example, about 30 seconds.

The BOE solution is an aqueous solution that contains an etchant and at least one, preferably, two or more alkanolamine compounds. The etchant may be a fluorine source, such as hydrogen fluoride. The BOE solution may contain the etchant at a concentration by weight within a range from about 0.25% to about 10%, preferably, from about 0.5% to about 5%, and more preferably, from about 1% to about 3%. In one example, the etchant is hydrogen fluoride at a concentration of about 2%. The BOE solution also contains water at a concentration by weight within a range from about 80% to about 98%, preferably, from about 85% to about 95%, and more preferably, from about 88% to about 94%. In one example, BOE solution contains about 92% water.

Alkanolamine compounds are contained within the BOE solutions. In general, the alkanolamine compounds complex or interact with the fluoride ions from the dissolved hydrogen fluoride or other etchant. Therefore, the partially complexed fluoride ions become comparatively less active towards higher density silicon oxides, silicate, or silicon containing materials on the surfaces of the substrate 200, such as within dielectric layer 204 and similar features. The alkanolamine compounds provide other desirable properties while acting as a wetting agent, a pH buffer, a fluoride buffer, a chelating agent, or a stabilizer for the etched silicon atoms leaving the surface of the substrate 200 and entering the BOE solution.

In one embodiment, two or more alkanolamine compounds may be combined at various ratios in order to control the viscosity of the BOE solution. In one example, the viscosity of the BOE solution is determined by a weight ratio of at least two alkanolamine compounds combined within the BOE solution. In another example, the viscosity is determined by a weight ratio of at least three alkanolamine compounds combined within the BOE solution. Substrate 200 may be exposed to a centrifugal spinning process while containing an aliquot of the BOE solution thereon, such as during process 110. The viscosity of the BOE solution may be adjusted in order to maintain a predetermined volume of the BOE solution on substrate 20 while being spun. Also, the wettability of substrate 200 and may be controlled by adjusting the viscosity of the BOE solution. Therefore, the selectivity of the etching may in part be controlled by the viscosity of the BOE solution. The BOE solution may have a dynamic viscosity of about 50 cP or less, preferably, about 40 cP or less, such as within a range from about 10 cP to about 30 cP, preferably, from about 12 cP to about 28 cP, and more preferably, from about 15 cP to about 25 cP. In one example, the viscosity is about 23 cP.

The weight ratio of a first alkanolamine compound to the second alkanolamine compound may be within a range from about 1 to about 10, in another example, within a range from about 1 to about 5, and in another example, within a range from about 1 to about 3, such as about 1.5 or about 1.1. The alkanolamine compounds that may be used to form the BOE solutions as described herein include monoalkanolamine compounds (RNH₂), dialkanolamine compounds (R₂NH), trialkanolamine compounds (R₃N), or combinations thereof, where each R is independently an alkanol group including methanol (HOCH₂—), ethanol (HOC₂H₄—), propanol (HOC₃H₆—), butanol (HOC₄H₈—), or derivatives thereof. In one embodiment, the preferred alkanolamine compounds include ethanolamine (EA, (HOCH₂CH₂)NH₂), diethanolamine (DEA, (HOCH₂CH₂)₂NH), triethanolamine (TEA, (HOCH₂CH₂)₃N), methanolamine ((HOCH₂)NH₂), dimethanolamine ((HOCH₂)₂NH), trimethanolamine ((HOCH₂)₃N), diethanolmethanolamine ((HOCH₂)N(CH₂CH₂OH)₂), ethanoldimethanolamine ((HOCH₂)₂N(CH₂CH₂OH)), derivatives thereof, or combinations thereof.

The BOE solution may contain a first alkanolamine compound at a concentration by weight within a range from about 0.5% to about 10%, preferably, from about 1% to about 5%, and more preferably, from about 2% to about 3%. Also, the BOE solution may contain a second alkanolamine compound at a concentration by weight within a range from about 0.5% to about 10%, preferably, from about 1% to about 5%, and more preferably, from about 2% to about 3%. While in some embodiments, a composition of the BOE solution contains two different alkanolamine compounds, other embodiments provide compositions containing a single alkanolamine compound, three alkanolamine compounds, or more. Therefore, the BOE solution may contain one alkanolamine compound, preferably two different alkanolamine compounds, and may contain three or more different alkanolamine compounds depending on desired viscosity of the BOE solution. In an alternative embodiment, the BOE solution may contain a third alkanolamine compound at a concentration by weight within a range from about 0.5% to about 10%, preferably, from about 1% to about 5%, and more preferably, from about 2% to about 3%. For example, the BOE solution may contain EA, DEA, and TEA. In one embodiment, the viscosity of the BOE solution may be increased by providing a higher weight ratio TEA:DEA. Alternatively, in another embodiment, the viscosity of the BOE solution may be decreased by providing a higher weight ratio EA:DEA.

In one example, the first alkanolamine compound may be DEA and the second alkanolamine compound may be TEA. In another example, the first alkanolamine compound is DEA the second alkanolamine compound is EA. In another example, the first alkanolamine compound is TEA the second alkanolamine compound is EA. In other examples, the first alkanolamine compound is DEA at a concentration within the BOE solution to have the viscosity of the BOE solution within a range from about 15 cP to about 25 cP or at a concentration by weight of the BOE solution within a range from about 1% to about 15%. In another example, the first alkanolamine compound is DEA at a concentration of about 3% and the second alkanolamine compound is TEA at a concentration of about 2%.

The BOE solution is formed as an acidic, aqueous solution. A pH adjusting agent may be added to adjust the pH value of the BOE solution. The BOE solution may contain a pH adjusting agent at a concentration to maintain a pH value of less than about 7, preferably, less than about 6, such as within a pH range from about 3.5 to about 5, preferably, from about 3.8 to about 4.8, and more preferably, from about 4 to about 4.5. The pH adjusting agent may include additional alkanolamine compounds (e.g. , EA, DEA, or TEA), additional HF or hydrofluoric acid, sulfuric acid, ammonium hydroxide, tetramethylammonium hydroxide, salts thereof, derivatives thereof, or combinations thereof. In one embodiment, the pH value of the BOE solution is adjusted to the point of zero charge (PZC) of silicon, such as within a pH range from about 4 to about 4.5. Generally, silicon oxide has a PZC at a pH value of about 3.5 or less. Therefore, in one embodiment, the BOE solution has a pH value of greater than about 3.5 and less than about 6.

The etching process to selectively remove native oxides over thermal oxides may use a pre-mixed BOE solution or an in-line mixing process that combines a BOE concentrate with water to generate the BOE solution. In one example, the BOE concentrate and water are mixed at the point-of-use to efficiently and effectively form the BOE solution. The BOE solution may be formed by diluting a BOE concentrate with various ratios of water. In one example, a BOE solution is formed by combining one volumetric equivalent of a BOE concentrate and two volumetric equivalents of deionized water. In another example, a BOE solution is formed by combining one volumetric equivalent of a BOE concentrate and three volumetric equivalents of deionized water. In another example, a BOE solution is formed by combining one volumetric equivalent of a BOE concentrate and four volumetric equivalents of deionized water. In another example, a BOE solution is formed by combining one volumetric equivalent of a BOE concentrate and six volumetric equivalents of deionized water.

In one example, a BOE solution contains by weight a DEA concentration from about 2% to about 4%, preferably about 3%, a TEA concentration from about 1% to about 3%, preferably about 2%, a HF concentration from about 1% to about 3%, preferably about 2%, and a water concentration from about 90% to about 96%, preferably, from about 91% to about 95%, and more preferably, about 93%. The BOE solution may have a pH value within a range from about 4 to about 4.5, such as about 4.25, and a viscosity within a range from about 15 cP to about 30 cP, such as about 23 cP.

In another example, a BOE solution contains by weight a DEA concentration from about 1% to about 3%, preferably about 2%, a TEA concentration from about 2% to about 4%, preferably about 3%, a HF concentration from about 1% to about 3%, preferably about 2%, and a water concentration from about 90% to about 96%, preferably, from about 91% to about 95%, and more preferably, about 93%. The BOE solution may have a pH value within a range from about 4 to about 4.5, such as about 4.25, and a viscosity within a range from about 15 cP to about 30 cP, such as about 25 cP.

In another example, a BOE solution contains by weight a DEA concentration from about 1% to about 10%, preferably about 5%, a HF concentration from about 1% to about 3%, preferably about 2%, and a water concentration from about 90% to about 96%, preferably, from about 92% to about 94%, and more preferably, about 93%. The BOE solution may have a pH value within a range from about 4 to about 4.5, such as about 4.25, and a viscosity within a range from about 15 cP to about 30 cP, such as about 18 cP.

In another example, a BOE solution contains by weight a TEA concentration from about 1% to about 10%, preferably about 5%, a HF concentration from about 1% to about 3%, preferably about 2%, and a water concentration from about 90% to about 96%, preferably, from about 92% to about 94%, and more preferably, about 93%. The BOE solution may have a pH value within a range from about 4 to about 4.5, such as about 4.25, and a viscosity within a range from about 15 cP to about 30 cP, such as about 30 cP.

In one embodiment of process 110, a BOE solution is applied to substrate 200 having native oxide surface 210 and specifically patterned areas containing thermal oxide, such as dielectric layer 204. The BOE solution contains 0.5 M DEA-TEA-HF (0.5 M of total alkanolamines), a pH value of about 4.25, and a viscosity of about 23 cP. Substrate 200 may be maintained at room temperature (about 20° C.) and exposed to the BOE solution for about 30 seconds. Thereafter, native oxide surface 210 may be completely removed, hydride layer 212 is formed and dielectric layer 204 received little or no etching. Substrate 200 may be thoroughly rinsed with water and dried by a gas flow (e.g. , N₂, H₂, Ar, or a mixture thereof) during process 120.

FIGS. 2C-2D illustrate a cross-sectional view of substrate 200 during a silicidation formation process and subsequent contact fill process, as described in one embodiment that may be implemented during process 130. FIG. 2C depicts metal layer 214 disposed over hydride surface 212 of silicon junction 202 and dielectric layer 204. In general, metal layer 214 contains a metal that forms a metal silicide with the silicon material contained in silicon junction 202 at exposed surface 203 during a subsequent thermal processing step. Metal layer 214 may contain nickel, titanium, tantalum, cobalt, molybdenum, tungsten, alloys thereof, nitrides thereof, or combinations thereof. Metal layer 214 may be selectively or non-selectively deposited using an ALD process, a PVD process, a CVD process, or an electroless deposition process. A preferred electroless process is further described in commonly assigned U.S. Ser. No. 60/703,538, filed Jul. 29, 2005, and in commonly assigned U.S. Ser. No. 60/731,624, filed Oct. 28, 2005, which are both herein incorporated by reference in their entirety. In one example, metal layer 214 contains a nickel-containing material deposited using an electroless deposition process. Metal layer 214 may be deposited having a thickness within a range from about 5 Å to about 100 Å, preferably, from about 10 Å to about 50 Å, and more preferably, from about 10 Å to about 30 Å.

Substrate 200 may be exposed to a thermal process, such as a conventional anneal process or a rapid thermal process (RTP) to form metal silicide layer 216 at the interface of metal layer 214 and silicon junction 202. Generally, the silicide formation process may be performed in a vacuum or inert environment to prevent the oxidation or damage to the surface of metal silicide layer 216 or other contact surfaces. Substrate 200 may be heated to a temperature within a range from about 300° C. to about 450° C. for a time period within a range from about 30 seconds to about 10 minutes. In one example, metal silicide layer 216 contains a nickel silicide material on exposed surface 203 at silicon junction 202. The silicide formation process step may be used to reduce the contact resistance between the metal layer 214 and silicon junction 202 within contact level aperture 206.

Optionally, a thin layer cobalt-containing layer may be deposited over metal silicide layer 216 to inhibit the diffusion of metal layer 214 into the subsequently deposited layers or other contact level aperture elements. In one example, a cobalt-containing layer is deposited before forming metal silicide layer 216 and thus is deposited directly on metal layer 214. In general the cobalt containing layer (not shown) is a binary alloy or ternary alloy, such as cobalt boride (CoB), cobalt phosphide (CoP), cobalt tungsten phosphide (CoWP), cobalt tungsten boride (CoWB), cobalt molybdenum phosphide (CoMoP), cobalt molybdenum boride (CoMoB), cobalt rhenium boride (CoReB), cobalt rhenium phosphide (CoReP), derivatives thereof, alloys thereof, or combinations thereof. In one aspect, the cobalt containing layer (not shown) may be deposited having a thickness within a range from about 5 Å to about 100 Å, preferably, from about 10 Å to about 50 Å, and more preferably, from about 10 Å to about 30 Å. Preferably, the cobalt containing layer is deposited using an electroless deposition process, such as processes described in commonly assigned U.S. Ser. No. 11/040,962, filed Jan. 22, 2005, and published as U.S. 2005-0181226, and in commonly assigned U.S. Ser. No. 10/967,644, filed Oct. 18, 2004, and published as U.S. 2005-0095830, which are both herein incorporated by reference in their entirety.

FIGS. 2C and 2E illustrate a cross-sectional view of substrate 200 during a barrier layer deposition process and subsequent contact fill process, as described in another embodiment that may be implemented during process 130. FIG. 2C depicts metal layer 214 disposed over hydride surface 212 of silicon junction 202 and dielectric layer 204. In general, metal layer 214 contains a metal, a metal nitride, or a metal silicon nitride. Metal layer 214 may contain tantalum, tantalum nitride, tantalum silicon nitride, titanium, titanium nitride, titanium silicon nitride, ruthenium, tungsten, tungsten nitride, alloys thereof, derivatives thereof, or combinations thereof. Metal layer 214 may be deposited or formed on sidewalls 205 of contact level aperture 206 and across hydride surface 212 and the field of substrate 200 by an ALD process, a CVD process, a PVD process, an electroless deposition process, or a combination thereof.

Metal layer 214 may contain a single layer of one material or multiple layers of varying materials. The composition of metal layer 214 may contain tantalum, tantalum nitride, tantalum silicon nitride, titanium, titanium nitride, titanium silicon nitride, ruthenium, tungsten, tungsten nitride, alloys thereof, derivatives thereof, or combinations thereof. In one example, metal layer 214 is formed by depositing a tantalum layer by a PVD process onto a tantalum nitride layer deposited by an ALD process. In another example, metal layer 214 is formed by depositing a tantalum layer by a PVD process onto a tantalum nitride layer deposited by a PVD process. In another example, metal layer 214 is formed by depositing a tantalum layer by an ALD process onto a tantalum nitride layer deposited by an ALD process.

Optionally, a seed layer (not shown) may be deposited on metal layer 214 prior to filling contact level aperture 206 with a conductive material to form contact plug 220. A seed layer may contain copper, ruthenium, cobalt, tantalum, titanium, tungsten, rhenium, palladium, platinum, nickel, alloys thereof, or combinations thereof and may be deposited by a PVD process, an ALD process, or an electroless deposition process.

Contact level aperture 206 may be filled with a conductive metal to form contact plug 220 thereon, as depicted in FIGS. 2D and 2E. The conductive metal contained within contact plug 220 may include copper, tungsten, aluminum, silver, alloys thereof, or combinations thereof. Contact plug 220 may be formed by depositing the conductive material during an ALD process, a PVD process, a CVD process, electrochemical plating process (ECP), an electroless deposition process, or combinations thereof. Contact plug 220 may be filled by a single conductive material during a single deposition process or contact plug 220 may be filled by multiple conductive materials during multiple deposition processes, such as by forming a seed layer, a bulk layer, and/or a subsequent fill layer. In one example, contact plug 220 is filled with copper or a copper alloy during an electroless deposition process. In another example, contact plug 220 is filled with tungsten or a tungsten alloy during an ALD process followed by a CVD process.

The processes described herein may be performed in an apparatus suitable for performing a buffered oxide etch (BOE) process or an electroless deposition process (EDP). A suitable apparatus includes the SLIMCELL™ processing platform that is available from Applied Materials, Inc. , located in Santa Clara, Calif. The SLIMCELL™ platform, for example, is an integrated system capable of etching a native oxide within a wet-clean cell during a BOE process and depositing a conductive material within an EDP cell. The SLIMCELL™ platform generally includes a wet-clean cell or etch cell and one or more EDP cells as well as one or more pre-deposition or post-deposition cell, such as spin-rinse-dry (SRD) cells or annealing chambers. Process systems, platforms, chambers, and cells useful for conducting BOE processes, as well as electroless deposition processes, as described herein, are further disclosed in commonly assigned U.S. Ser. No. 10/059,572, entitled “Electroless Deposition Apparatus,” filed Jan. 28, 2002, and published as U.S. 2003-0141018, U.S. Ser. No. 10/965,220, entitled, “Apparatus for Electroless Deposition,” filed on Oct. 14, 2004, and published as U.S. 2005-0081785, U.S. Ser. No. 10/996,342, entitled, “Apparatus for Electroless Deposition of Metals on Semiconductor Wafers,” filed on Nov. 22, 2004, and published as U.S. 2005-0160990, U.S. Ser. No. 11/043,442, entitled, “Apparatus for Electroless Deposition of Metals on Semiconductor Wafers,” filed on Jan. 26, 2005, and published as U.S. 2005-0263066, U.S. Ser. No. 11/175,251, entitled, “Apparatus for Electroless Deposition of Metals on Semiconductor Wafers,” filed on Jul. 6, 2005, and published as U.S. 2005-0260345, U.S. Ser. No. 11/192,993, entitled, “Integrated Electroless Deposition System,” filed on Jul. 29, 2005, and published as U.S. 2006-0033678, which are each incorporated by reference to the extent not inconsistent with the claimed aspects and description herein.

A “substrate surface,” as used herein, refers to any substrate or material surface formed on a substrate upon which film processing is performed. For example, a substrate surface on which processing may be performed include materials such as monocrystalline, polycrystalline, or amorphous silicon, strained silicon, silicon on insulator (SOI), doped silicon, fluorine-doped silicate glass (FSG), silicon germanium, germanium, gallium arsenide, glass, sapphire, silicon oxide, silicon nitride, silicon oxynitride, or carbon doped silicon oxides, such as SiOₓC_{y}, for example, BLACK DIAMOND® low-k dielectric, available from Applied Materials, Inc., located in Santa Clara, Calif. Substrates may have various dimensions, such as 200 mm or 300 mm diameter wafers, as well as, rectangular or square panes. Substrates on which embodiments of the invention may be useful include, but are not limited to semiconductor wafers, such as crystalline silicon (e.g. , Si<100> or Si<111>), silicon oxide, strained silicon, silicon germanium, doped or undoped polysilicon, doped or undoped silicon wafers, and patterned or non-patterned wafers. Substrates made of glass or plastic, which, for example, are commonly used to fabricate flat panel displays and other similar devices, may also be used during embodiments described herein.

### EXPERIMENTAL

### Example 1—DEA-HF Concentrate

Diethanolamine (DEA) 99.5% (1 mole, 105.1 g) is heated to its melting point and dissolved in minimal ultra pure water to form a concentrated solution within a 500 mL vessel. To the vessel, 200 mL of diluted 10% wt. hydrofluoric acid (HF), or 1 mole of HF is added slowly enough to prevent excessive heating of the solution. The pH value of the solution is adjusted to a desired pH range with the direct addition of 48% wt. HF or 33% wt. tetramethylammonium hydroxide (TMAH), or a non-fluoride containing acid such as sulfuric acid (H₂SO₄). The solution is diluted with pure water to a volume of 500 mL. The DEA-HF concentrate has a DEA concentration of about 2 M.

### Example 1.1—DEA-HF Concentrate of pH 6-7

A 500 mL of DEA-HF concentrate (about 500 g) having a pH value within a range from about 6 to about 7 contains about 105 g of DEA (about 20% wt.), about 20 g of HF (about 5% wt.), and about 375 g (about 75% wt.) water.

### Example 1.2—DEA-HF Concentrate of pH 4-4.5

A 500 mL of DEA-HF concentrate (about 500 g) having a pH value within a range from about 4 to about 4.5 contains about 105 g of DEA (about 20% wt.), about 35 g of HF (about 7% wt.), and about 365 g (about 73% wt.) water. The pH value is adjusted to the point of zero charge (PZC) of silicon, which is also within a range from about 4 to about 4.5.

### Example 1.3—DEA-HF Solution

The 2 M DEA concentrate prepared in Example 1.2 is diluted by mixing with water at a ratio of 1:4. The 2 L of DEA-HF solution contains about 105 g of DEA (about 5% wt.), about 35 g of HF (about 2% wt.), and about 1860 g (about 93% wt.). The DEA-HF solution has a DEA concentration of about 0.5 M.

### Example 2—DEA-TEA-HF Concentrate

DEA (1 mole, about 55 g) and triethanolamine (TEA) (1 mole, about 50 g) are heated to its melting point and dissolved in minimal ultra pure water to form a concentrated solution within a 500 mL vessel. To the vessel, 200 mL of diluted 10% wt. HF, or 1 mole of HF is added slowly enough to prevent excessive heating of the solution. The pH value of the solution is adjusted to a desired pH range with the direct addition of 48% wt. HF or 33% wt. TMAH, or a non-fluoride containing acid such as sulfuric acid. The solution is diluted with pure water to a volume of 500 mL. The solution has a pH value of about 4-4.5. The DEA-TEA-HF concentrate has a DEA-TEA concentration of about 2 M and a DEA:TEA weight ratio of about 1.1.

### Example 2.1—DEA-TEA-HF Concentrate of pH 4-4.5

A 500 mL of DEA-TEA-HF concentrate (about 500 g) having a pH value within a range from about 4 to about 4.5 contains about 55 g of DEA (about 10% wt.), about 50 g of TEA (about 10% wt.), about 35 g of HF (about 7% wt.), and about 365 g (about 73% wt.) water. The pH value is adjusted to the point of zero charge (PZC) of silicon, which is also within a range from about 4 to about 4.5.

### Example 2.2—DEA-TEA-HF Solution

The 2 M DEA-TEA concentrate prepared in Example 2.1 is diluted by mixing with water at a ratio of 1:4. The 2 L of DEA-TEA-HF solution contains about 55 g of DEA (about 3% wt.), about 50 g of DEA (about 2% wt.), about 35 g of HF (about 2% wt.), and about 1860 g (about 93% wt.). The DEA-TEA-HF solution has a DEA-TEA concentration of about 0.5 M and a viscosity of about 23.

### Example 3—Process Using DEA-TEA-HF Solution

A substrate is exposed to a 25 mL sample of the DEA-TEA-HF solution as described in Example 2.2. The silicon substrate, at room temperature (20° C.), has the regions of the native silicon oxide exposed in specifically patterned areas. A treatment time of 30 s or less was sufficient to completely remove the native oxide while causing little or no etching of the dielectric layers.

While the foregoing is directed to embodiments of the invention, other and further embodiments of the invention may be devised without departing from the basic scope thereof, and the scope thereof is determined by the claims that follow.

1. A composition of a buffered oxide etch solution, comprising:
diethanolamine at a concentration by weight within a range from about 0.5% to about 10%;
triethanolamine at a concentration by weight within a range from about 0.5% to about 10%;
hydrogen fluoride at a concentration by weight within a range from about 0.5% to about 10%;
water at a concentration by weight within a range from about 80% to about 98%;
a pH value within a range from about 3.5 to about 5; and
a viscosity within a range from about 10 cP to about 30 cP.

2. The composition of claim 1, wherein:
the diethanolamine is at a concentration within a range from about 1% to about 5%;
the triethanolamine is at a concentration within a range from about 1% to about 5%;
the hydrogen fluoride is at a concentration within a range from about 1% to about 5%;
the water is at a concentration within a range from about 85% to about 95%;
the pH value is within a range from about 3.8 to about 4.8; and
the viscosity is within a range from about 12 cP to about 28 cP.

3. The composition of claim 2, wherein:
the diethanolamine is at a concentration within a range from about 2% to about 3%;
the triethanolamine is at a concentration within a range from about 2% to about 3%;
the hydrogen fluoride is at a concentration within a range from about 1% to about 3%;
the water is at a concentration within a range from about 88% to about 94%;
the pH value is within a range from about 4 to about 4.5; and
the viscosity is within a range from about 15 cP to about 25 cP.

4. The composition of claim 3, wherein:
the diethanolamine is at a concentration of about 3%;
the triethanolamine is at a concentration of about 2%;
the hydrogen fluoride is at a concentration of about 2%;
the water is at a concentration of about 92%;
the pH value is within a range from about 4 to about 4.5; and
the viscosity is within a range from about 15 cP to about 25 cP.

5. The composition of claim 1, wherein a weight ratio of the diethanolamine to the triethanolamine is within a range from about 1 to about 5.

6. The composition of claim 5, wherein the weight ratio is within a range from about 1 to about 1.5.

7. The composition of claim 6, wherein the viscosity is about 23 cP.

8. The composition of claim 1, wherein the pH value is within a range from about 4 to about 4.5.

9. The composition of claim 8, further comprising a pH adjusting agent selected from the group consisting of sulfuric acid, ammonium hydroxide, tetramethylammonium hydroxide, derivatives thereof, and combinations thereof.

10. The composition of claim 1, further comprising ethanolamine.

11. The composition of claim 10, wherein the ethanolamine is at a concentration by weight within a range from about 1% to about 15%.

12. The composition of claim 10, wherein the ethanolamine is at a concentration to have the viscosity within a range from about 15 cP to about 25 cP.

13. A method for selectively removing an oxide layer from a substrate surface, comprising:
providing a substrate having a native oxide surface and a feature surface;
providing a buffered oxide etch solution comprising:
diethanolamine at a concentration by weight within a range from about 0.5% to about 10%;
triethanolamine at a concentration by weight within a range from about 0.5% to about 10%;
hydrogen fluoride at a concentration by weight within a range from about 0.5% to about 10%;
water at a concentration by weight within a range from about 80% to about 98%;
a pH value within a range from about 3.5 to about 5; and
a viscosity within a range from about 10 cP to about 30 cP; and
exposing the substrate to the buffered oxide etch solution to remove the native oxide surface, form a native surface, and preserve the feature surface on the substrate.

14. The method of claim 13, wherein the pH value is adjusted to a point of zero charge of silicon.

15. The method of claim 14, wherein the pH value is within a range from about 4 to about 4.5.

16. The method of claim 13, wherein a weight ratio of the diethanolamine to the triethanolamine is within a range from about 1 to about 5.

17. The method of claim 16, wherein the weight ratio is within a range from about 1 to about 1.5.

18. The method of claim 13, wherein:
the diethanolamine is at a concentration within a range from about 1% to about 5%;
the triethanolamine is at a concentration within a range from about 1% to about 5%;
the hydrogen fluoride is at a concentration within a range from about 1% to about 5%;
the water is at a concentration within a range from about 85% to about 95%;
the pH value is within a range from about 3.8 to about 4.8; and
the viscosity is within a range from about 12 cP to about 28 cP.

19. The method of claim 18, wherein:
the diethanolamine is at a concentration of about 3%;
the triethanolamine is at a concentration of about 2%;
the hydrogen fluoride is at a concentration of about 2%;
the water is at a concentration of about 92%;
the pH value is within a range from about 4 to about 4.5; and
the viscosity is within a range from about 15 cP to about 25 cP.

20. The method of claim 13, wherein the substrate is exposed to the buffered oxide etch solution for a time period within a range from about 10 seconds to about 120 seconds.

21. The method of claim 20, wherein the time period is within a range from about 15 seconds to about 60 seconds.

22. A composition of a buffered oxide etch solution, comprising:
a first alkanolamine compound at a concentration by weight within a range from about 0.5% to about 10%;
a second alkanolamine compound at a concentration by weight within a range from about 0.5% to about 10%;
hydrogen fluoride at a concentration by weight within a range from about 0.5% to about 10%;
water at a concentration by weight within a range from about 80% to about 98%;
a pH value within a range from about 3.5 to about 5; and
a viscosity within a range from about 10 cP to about 30 cP.

23. The composition of claim 22, wherein:
the first alkanolamine compound is at a concentration within a range from about 1% to about 5%;
the second alkanolamine compound is at a concentration within a range from about 1% to about 5%;
the hydrogen fluoride is at a concentration within a range from about 1% to about 5%;
the water is at a concentration within a range from about 85% to about 95%;
the pH value is within a range from about 3.8 to about 4.8; and
the viscosity is within a range from about 12 cP to about 28 cP.

24. The composition of claim 23, wherein:
the first alkanolamine compound is at a concentration within a range from about 2% to about 3%;
the second alkanolamine compound is at a concentration within a range from about 2% to about 3%;
the hydrogen fluoride is at a concentration within a range from about 1% to about 3%;
the water is at a concentration within a range from about 88% to about 94%;
the pH value is within a range from about 4 to about 4.5; and
the viscosity is within a range from about 15 cP to about 25 cP.

25. The composition of claim 24, wherein:
the first alkanolamine compound is at a concentration of about 3%;
the second alkanolamine compound is at a concentration of about 2%;
the hydrogen fluoride is at a concentration of about 2%;
the water is at a concentration of about 92%;
the pH value is within a range from about 4 to about 4.5; and
the viscosity is within a range from about 15 cP to about 25 cP.

26. The composition of claim 22, wherein a weight ratio of the first alkanolamine compound to the second alkanolamine compound is within a range from about 1 to about 5.

27. The composition of claim 26, wherein the first alkanolamine compound is diethanolamine the second alkanolamine compound is triethanolamine.

28. The composition of claim 26, wherein the first alkanolamine compound is diethanolamine the second alkanolamine compound is ethanolamine.

29. The composition of claim 26, wherein the first alkanolamine compound is triethanolamine the second alkanolamine compound is ethanolamine.

30. The composition of claim 22, wherein the first alkanolamine compound and the second alkanolamine compound are different compounds and are each independently selected from the group consisting of ethanolamine, diethanolamine, triethanolamine, and derivatives thereof.

31. The composition of claim 22, wherein the first alkanolamine compound is diethanolamine at a concentration by weight within a range from about 1% to about 15%.

32. The composition of claim 22, wherein the first alkanolamine compound is diethanolamine is at a concentration to have the viscosity within a range from about 15 cP to about 25 cP.

33. A composition of a buffered oxide etch solution, comprising:
a first alkanolamine and a second alkanolamine compound at a weight ratio concentration to form a viscosity within a range from about 10 cP to about 30 cP;
hydrogen fluoride at a concentration by weight within a range from about 0.5% to about 10%;
water at a concentration by weight within a range from about 80% to about 98%;
a pH value within a range from about 3.5 to about 5; and
a viscosity within a range from about 10 cP to about 30 cP.

34. The composition of claim 33, wherein the weight ratio concentration of the first alkanolamine compound to the second alkanolamine compound is within a range from about 1 to about 5.

35. The composition of claim 34, wherein the viscosity is within a range from about 15 cP to about 25 cP.

36. A method for forming a buffered oxide etch solution comprising combining a first alkanolamine compound and a second alkanolamine compound at a predetermined ratio to form a predetermined viscosity of a buffered oxide etch solution, wherein the buffered oxide etch solution comprises:
the first alkanolamine compound at a concentration by weight within a range from about 0.5% to about 10%;
the second alkanolamine compound at a concentration by weight within a range from about 0.5% to about 10%;
hydrogen fluoride at a concentration by weight within a range from about 0.5% to about 10%; and
water at a concentration by weight within a range from about 80% to about 98%.

37. The method of claim 36, wherein the predetermined viscosity is within a range from about 10 cP to about 30 cP.

38. The method of claim 37, wherein the buffered oxide etch solution has a pH value within a range from about 3.5 to about 5.

39. The method of claim 37, wherein a weight ratio of the first alkanolamine compound to the second alkanolamine compound is within a range from about 1 to about 5.

40. The method of claim 39, wherein the first alkanolamine compound is diethanolamine the second alkanolamine compound is triethanolamine or ethanolamine.
